(19) United States
(12) Patent Application Publication
(10) Pub. No.: US 2015/0269024 A1
(43) Pub. Date: Sep. 24, 2015

(54) INDEPENDENT ECC CHIP DEVICE, A MOTHERBOARD, AND A COMPUTER SYSTEM

(71) Applicant: AMD Products (China) Co., Ltd., Beijing (CN)

(72) Inventors: Michael Xie, Beijing (CN); Jack Li, Beijing (CN)

(21) Appl. No.: 14/309,212

(22) Filed: Jun. 19, 2014

(30) Foreign Application Priority Data
Mar. 21, 2014 (CN) 201420131654.3

(51) Int. Cl. G06F 11/10

(52) U.S. Cl. CPC G06F 11/1076

(57) ABSTRACT

The present invention relates to an independent ECC chip device, a motherboard, and a computer System. The computer system of present invention comprises a memory controller, at least one Non-ECC memory module, and an independent ECC chip device, wherein the memory controller is coupled with the independent ECC chip device and the at least one Non-ECC memory module for providing ECC memory in the system. Through adding an independent ECC chip device and ECC chip socket, the computer system of present invention will have an ECC function without using a general and expensive ECC memory module, which can both save cost and enhance the flexibility and reliability of the computer system.

### CROSS REFERENCE TO RELATED APPLICATION

This application claims the benefit of Chinese Patent Application No. 201420131654.3, filed Mar. 21, 2014.

### TECHNICAL FIELD OF THE INVENTION

The present invention relates generally to computer systems and memory. More specifically, the present invention relates to an independent Error-Correcting Code (Error Checking and Correction, ECC) chip device, a motherboard having an independent ECC chip socket, and a computer system comprising the independent ECC chip device and the motherboard.

### BACKGROUND

ECC memory is a kind of computer data storage that can detect and correct data errors. In contrast, non-ECC memory cannot detect errors and/or cannot correct errors.

ECC memory is generally implemented by using RAM modules that contain extra memory bits, and memory controllers that use these memory bits. For example, typically, a non-ECC RAM module will contain 2, 4, or 8 chips, while a corresponding ECC RAM module will contain 3, 5, or 9 chips. The extra chip provides the extra memory bits and is used for ECC coding.

FIG. 1 shows a component diagram of a conventional computer system 100 with ECC memory in prior art. As shown in FIG. 1, the conventional computer system 100 usually comprises a memory controller 110 and a memory 120, wherein the memory 120 comprises an ECC memory module. When using ECC memory, a computer system protects against data corruption and thus has a more reliable performance and fewer crashes than when using non-ECC memory. But at the same time, ECC memory is more expensive than non-ECC memory. Thus, non-ECC memory is extensively used in many computer systems such as embedded systems, personal computers, laptops, etc.

### SUMMARY

It would be desirable to provide a computer system that would allow use of inexpensive non-ECC memory modules, but still have allow for ECC functionality if so desired. To achieve this purpose and overcome other disadvantages, the present invention provides an independent ECC chip device, a motherboard having an independent ECC chip socket, and a computer system comprising the independent ECC chip device and the motherboard. Through the devices and system of present invention, it is not necessary to remove or replace non-ECC memory in a computer system in order to achieve an ECC function. Thus, much cost is saved and the flexibility and reliability of the computer system is also enhanced.

In an example embodiment embodying a first aspect of present invention, an independent ECC chip device is provided. The ECC chip device consists of a connecting card and a memory chip configured to detect and correct memory errors, the connecting card being configured to be coupled with the memory chip.

In an example embodiment embodying a second aspect of present invention, a motherboard is provided. The motherboard comprises at least one memory socket supporting an ECC and/or Non-ECC memory module. The motherboard further comprises an independent ECC chip socket which is configured to be coupled with an independent ECC chip device. The ECC chip socket is coupled with the at least one memory socket.

In an example embodiment embodying a third aspect of present invention, a computer system is provided. The computer system comprises a memory controller, a Non-ECC memory module, and an independent ECC chip device wherein the memory controller is coupled with the independent ECC chip device and the Non-ECC memory module.

Other aspects and embodiments are described herein below.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a component diagram of a conventional computer system with ECC memory in prior art;

FIG. 2 shows a schematic diagram of an independent ECC chip device according to an exemplary embodiment of present invention;

FIG. 3 shows a schematic diagram of a motherboard having an independent ECC chip socket according to an exemplary embodiment of present invention; and

FIG. 4 shows a schematic component diagram of a computer system according to one explanatory embodiment of the present invention.

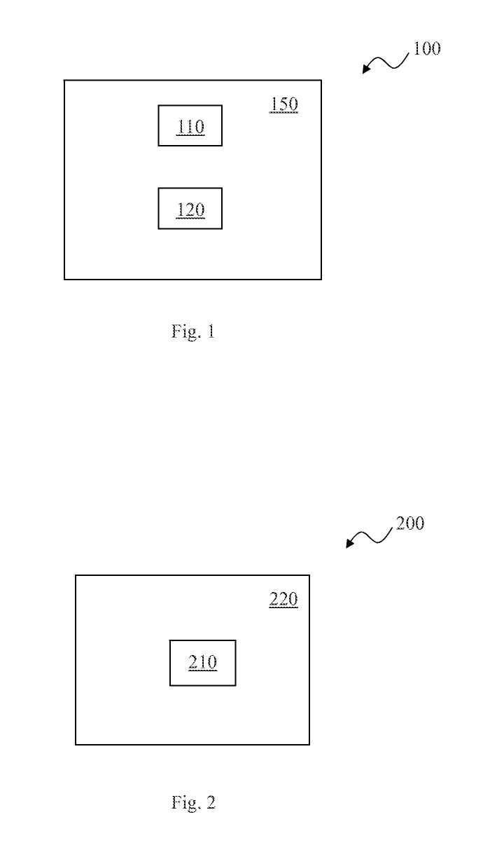

### DETAILED DESCRIPTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well-known components and structures have not been described in detail in order to not unnecessarily obscure the present invention.

In the following, an independent ECC chip device, a motherboard having an independent ECC chip socket and a computer system according to exemplary embodiments of the present invention will be described in detail with reference to FIGS. 2-4.

FIG. 2 shows an exemplary embodiment of an independent ECC chip device 200. As shown in FIG. 2, the independent ECC chip device 200 comprises an ECC chip 210 and a connecting card 220. The ECC chip 210 is a memory chip configured to detect and correct memory errors. The ECC chip 210 is mounted on the connecting card 220 and coupled with it. The connecting card 220 of present invention is a separate connecting card which is exclusively used for the ECC chip 210 to be mounted thereon and there are no other chips being mounted on the connecting card 220. In one embodiment, the ECC chip 210 can be coupled with the connecting card 220 by soldering connecting portions of the ECC chip 210 with connecting portions of the connecting card 220.

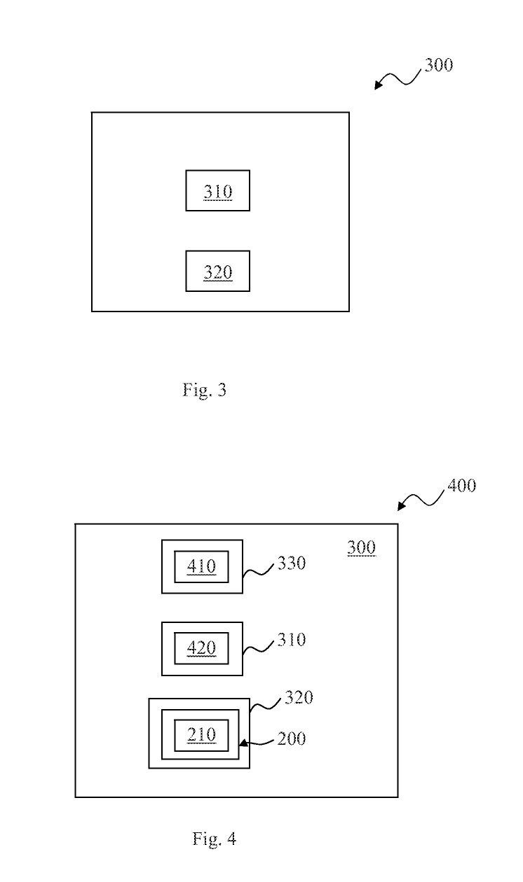

FIG. 3 shows an exemplary embodiment of a motherboard 300. The motherboard 300 comprises at least one memory sockets 310 which can support either a Non-ECC memory module and/or an ECC memory module. Only one memory socket 310 is exemplarily shown in FIG. 3. As used herein, a “Non-ECC memory module” means a memory module comprising a number of memory chips wherein the number of memory chips is not divisible by three or five. The motherboard 300 also comprises a plurality of sockets (not shown) for coupling a plurality of other components of a computer system, which may include by way of non-limiting example any of a memory controller, input device, output device, etc. A remarkable feature of the motherboard 300 is that it further comprises an independent ECC chip socket 320. The ECC chip socket 320 is configured to couple with an ECC chip device such as that shown in FIG. 2 as described above. In addition, the ECC chip socket 320 is further coupled to the memory socket 310 via conductive wires in the motherboard 300.

FIG. 4 shows an exemplary embodiment of a computer system 400 of the present invention. As shown in FIG. 4, the computer system 400 comprises a memory controller 410 and a Non-ECC memory module 420. A remarkable feature of the computer system 400 is that its motherboard uses the motherboard 300 as described above by reference to FIG. 3. And, the computer system 400 further comprises the independent ECC chip device 200 as described above by reference to FIG. 2. The Non-ECC memory module 420 can be coupled with the motherboard 300 through the memory socket 310 on the motherboard 300. The memory controller 410 can be coupled with the motherboard 300 via a socket 330 on the motherboard 300. The ECC chip device 200 may be coupled with the ECC chip socket 320 of the motherboard 300 such that the Non-ECC memory module 420 and the ECC chip 210 can be coupled with the memory controller 410.

As such, although the memory module of the computer system of the present invention is a Non-ECC memory module, through adding an independent ECC socket on the motherboard and plugging in an independent ECC chip device in the ECC socket, the computer system of the present invention will have an ECC function, i.e., providing an ECC memory in the computer system. Users can use a general Non-ECC memory module and plug the ECC chip device of the present invention into the motherboard to get ECC function without needing to replace the Non-ECC memory module with a general ECC memory module, which can achieve the purpose of both saving cost and enhancing the flexibility and reliability of the computer system.

In one exemplary embodiment, the Non-ECC memory module can be a double data rate 3 (DDR3), buffered or unbuffered Dual In-Line Memory Modules (UDIMM). Of course, in other embodiments, the Non-ECC memory also can be other kinds of memory module.

Although features and elements are described above in particular combinations, each feature or element can be used alone without the other features and elements or in various combinations with or without other features and elements. It will be apparent to those skilled in the art that various modifications and variations can be made to the embodiments described herein without departing from the spirit and scope of the claimed subject matter. Thus, it is intended that the specification cover the modifications and variations of the various embodiments described herein, provided such modification and variations come within the scope of the appended claims and their equivalents.

What is claimed is:

1. An independent ECC chip device, consisting of a connecting card and a memory chip configured to detect and correct memory errors, the connecting card being configured to be coupled with the memory chip.

2. The independent ECC chip device of claim 1, wherein the connecting card is further configured to be coupled with a motherboard.

3. A motherboard comprising at least one memory socket supporting an ECC and/or Non-ECC memory module, the motherboard further comprising an independent ECC chip socket which is configured to be coupled with the independent ECC chip device of claim 1, and the independent ECC chip socket being coupled with the at least one memory socket.

4. The motherboard of claim 3, characterized in that the at least one memory socket is a double data rate 3 (DDR3), buffered or unbuffered Dual In-Line Memory Modules (DIMM) socket.

5. A computer system comprising a memory controller, at least one Non-ECC memory module, and an independent ECC chip device according to claim 1, wherein the memory controller is coupled with the independent ECC chip device and the at least one Non-ECC memory module for providing ECC memory in the system.

6. The computer system of claim 5, characterized in that the at least one Non-ECC memory module is a double data rate 3 (DDR3) buffered or unbuffered Dual In-Line Memory Module (DIMM).
